(19) United States
(12) Patent Application Publication
(10) Pub. No.: US 2007/0245383 A1
(43) Pub. Date: Oct. 18, 2007

(54) System and method for inferface navigation

(76) Inventors: Madhav P. Bhide, New Brunswick, NJ (US); David M. Palmieri, Freehold Township, NJ (US)

Correspondence Address: Daniel F. Coughlin, Esq.;DREIER LLP, 499 Park Avenue, New York, NY, 10022, US

(21) Appl. No.: 11/645,227

(22) Filed: Dec. 21, 2006

Related U.S. Application Data
(60) Provisional application No. 60/752,650, filed on Dec. 21, 2005.

(51) Int. Cl. G06F 13/00

(52) U.S. Cl. 725/60

(57) ABSTRACT

Described is a system and method for interface navigation. The method comprises receiving query data via a website, identifying response data based on the query data, the response data including audible response data and visual response data, outputting the audible response data via an audible output device and outputting the visual response data on a display.

### PRIORITY CLAIM

The present application claims priority to U.S. Provisional Application No. 60/752,650, filed Dec. 21, 2005, the entire disclosure of which is expressly incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

The invention disclosed herein relates generally to facilitating navigation of a user interface. More specifically, the present invention relates to a query processing system for responding to queries and providing guidance for use of the user interface.

### BACKGROUND OF THE INVENTION

A conventional e-commerce company will create a website having a user interface which is both informative and user-friendly so that a customer can research and complete a purchase thereon. However, the customer may feel uncomfortable about entering personal and/or purchase information (e.g., address, phone number, credit card number, etc.) on the user interface, and, as a result, call into (or instant message) a customer service center to speak with a live customer service representative before completing the purchase. Maintaining the customer service center may represent a significant expense for the e-commerce company. Thus, there exists a need for customer service system which facilitates navigation and use of the user interface.

### SUMMARY OF THE INVENTION

The present invention relates to a system and method for interface navigation. The method comprises receiving query data via a website, identifying response data based on the query data, the response data including audible response data and visual response data, outputting the audible response data via an audible output device and outputting the visual response data on a display.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 shows an exemplary embodiment of a system for interface navigation according to the present invention;

FIG. 2 shows an exemplary embodiment of a webpage according to the present invention;

FIG. 3 shows an exemplary embodiment of a method for interface navigation according to the present invention; and

FIG. 4 shows an exemplary embodiment of a lookup table according to the present invention.

### DETAILED DESCRIPTION OF THE PREFERRED EMBODIMENTS

In the following description of the preferred embodiments, reference is made to the accompanying drawings that form a part hereof, and in which is shown by way of illustration exemplary embodiments in which the invention may be practiced. It is to be understood that other embodiments may be utilized and structural changes may be made without departing from the scope of the present invention.

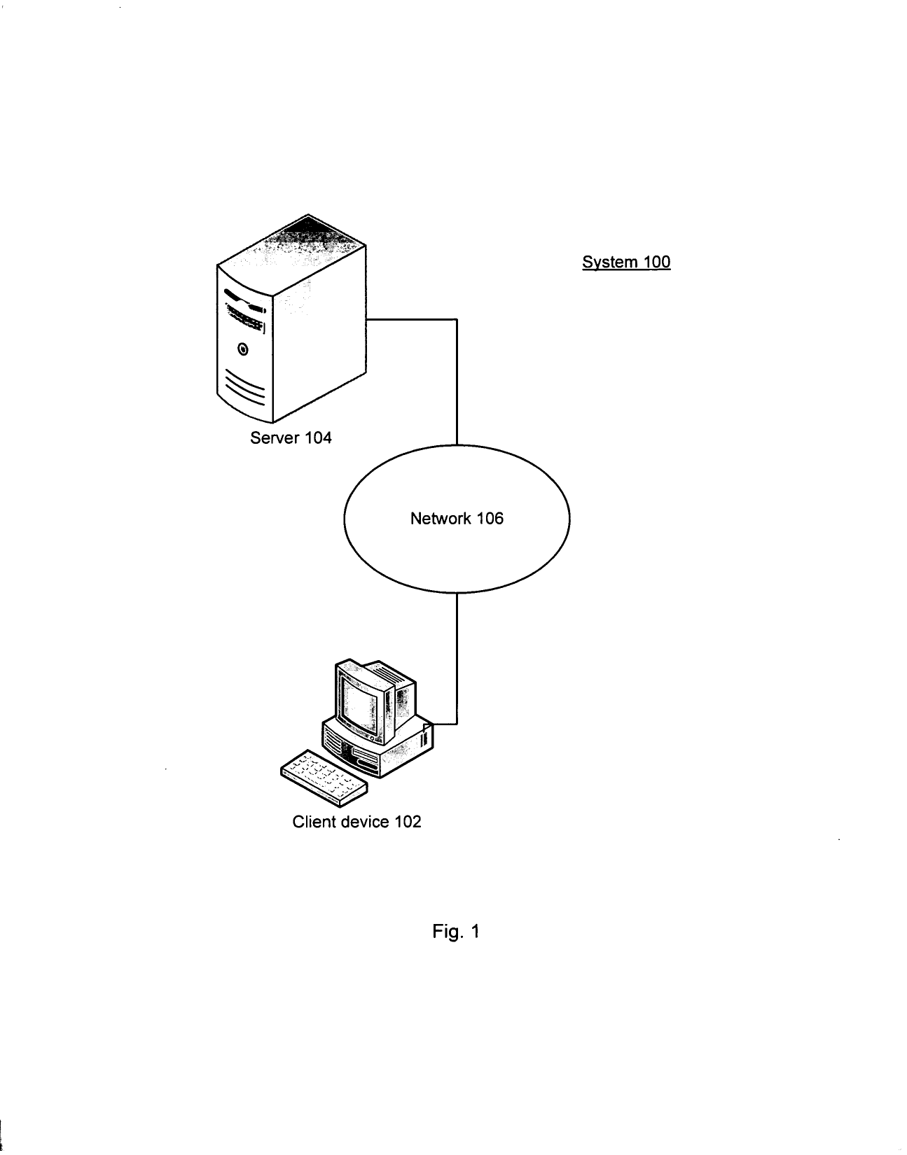

FIG. 1 shows an exemplary embodiment of a system 100 for interface navigation according to the present invention. The system 100 may comprises a server 102 communicatively interconnected to a client device 104 via a communications network 106 (e.g., a wired/wireless LAN/WAN, a cellular network, the Internet, an intranet, a VPN, a PSTN, etc.). The server 102 and the client device 104 may be processor-based computing devices which include memory and network connection ports for communicating data on the network 106. For example, the client device 104 may be a PC, laptop, mobile phone, PDA, tablet computer, handheld computer, smart appliance (e.g., scanner, copier, facsimile machine), etc. which may utilize a web browser (e.g., a VoiceXML browser) or command-line interface for allowing a user to interface with devices on the network 106. The server 102 may be a web-based application server, e.g., Apache Tomcat®, having a Java Servlet container. Those of skill in the art understand that any number of servers 102 and client devices 104 may be connected to the network 106.

The server 102 may host a website and serve a request for a webpage in the website from the client device 104. As is known in the art, the website may comprise one or more of the webpages, and the webpages may include any combination of text, video and/or audio data. The server 102 may communicate with the client device 104 using a conventional TCP/IP packet exchange, and a Session Initiation Protocol (SIP) may be utilized for VoIP communications. For example, a SIP Agent on the web browser may establish a connection to an SIP platform at the server 102. In the exemplary embodiment, the website is directed to an e-commerce application (e.g., selling airline tickets), and the webpages may include destination listings, reservation times and prices, carrier descriptions, purchase forms, etc. Those of skill in the art will understand that the website may be directed to any application (completely passive to fully interactive), and the webpages may include content corresponding to the application.

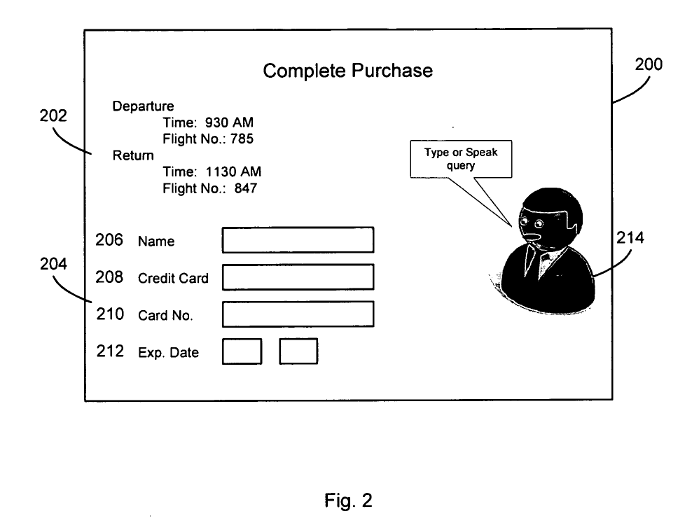

FIG. 2 shows an exemplary embodiment of a webpage 200 of the website according to the present invention. The webpage 200 may be a purchase form including purchase summary data 202 (e.g., flight times, numbers and prices) and form components 204 that require purchase data for completing a transaction. For example, the form components 204 may include a name field 206, a credit card type field 208, a credit card number field 210 and a credit card expiration date field 212. When the customer enters the purchase data into the form components 204, the server 102 may confirm authorization for the transaction as is known in the art.

In the exemplary embodiment, an animated customer service representative (ACSR) 214 may be displayed along with the webpage 200 in the web browser of the client device 104. The ACSR 214 may be a graphical representation of a human, animal, object, etc. that may be animated in synchronization with responses to queries and/or machine events (e.g., mouse clicks, keystrokes, scrolling, touches on a touch screen, etc.). For example, the human may move its lips in synchronization with an audible response being output, as will be described further below. In the exemplary embodiment, the ACSR 214 is a construct (e.g., a Flash presentation) embedded in the webpage 200 that provides information/guidance relating to the website hosted by the server 102. That is, in this embodiment, the ACSR 214 is site-specific. In another exemplary embodiment, the ACSR 214 may be a program which is stored and executed on the client device 104. In this embodiment, the ACSR 214 may be user-specific and utilized on any website (or other application interface) utilized by the customer. As will be explained further below, the ACSR 214 may answer questions from the customer, provide information/guidance regarding components of the webpage 200, perform error/spell checking for information input by the customer, etc.

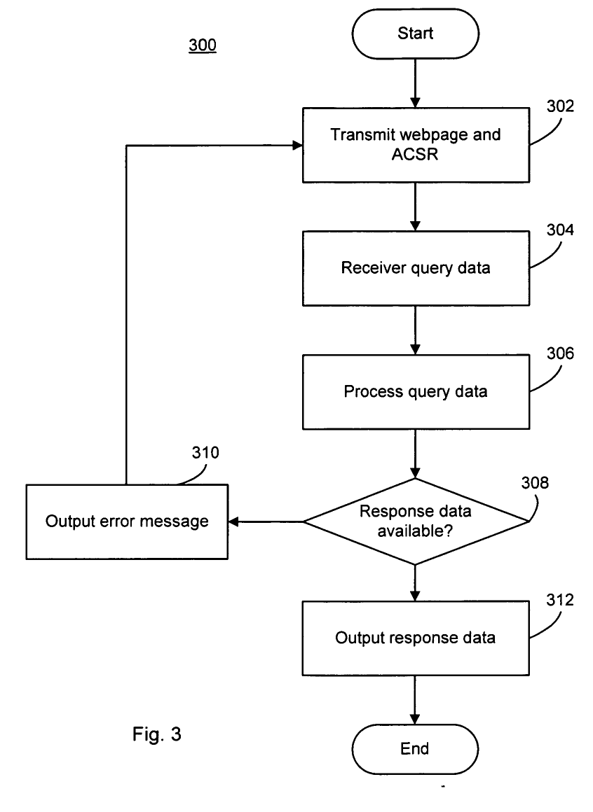

FIG. 3 shows an exemplary embodiment of a method 300 for interface navigation according to the present invention. While the method 300 will be described with reference to the system 100 and the webpage 200, those of skill in the art will understand that the method 300 may be utilized to, for example, search for items stored on a database or a memory of the client device 104, install and/or utilize software or hardware, etc. Furthermore, the exemplary embodiment of the method 300 is described with reference to the ACSR 214 being stored at the server 102 and delivered along with the webpage 200. However, as stated above, the ACSR 214 may be stored on the client device 104 and utilized across various webpages, software applications, etc.

In step 302, the webpage 200 and the ACSR 214 are transmitted to the client device 104, and the ACSR 214 may be displayed, along with the webpage 200, in the web browser. Those of skill in the art will understand that the ACSR 214 may be downloaded to the client device 104 upon an initial or any subsequent request for a webpage from the server 104. For example, the server 104 may not download the ACSR 214 with a homepage, because the customer may have inadvertently surfed to a URL of the website or may want to browse the webpage unaccompanied by the ACSR 214. In other exemplary embodiments, the customer may request or activate the ACSR 214.

In step 304, query data is received by the ACSR 214. As shown in FIG. 2, the ACSR 214 may prompt the customer to enter the query data (as text) into a text box 216 and/or (audibly) by speaking the query data. In the latter instance, the web browser on the client device 104 may be a VoiceXML browser, or voice recognition and conversion software (e.g., speech-to-text) that processes the query data and generates a corresponding text version thereof.

In step 306, the query data is processed to identify response data. For example, the query data may be input into a natural language processing arrangement that parses the query data and creates at least one combination of terms and/or characters/operators (modified query data) corresponding thereto. The processing may further include a translation arrangement for translating the query data into a language utilized by the webpage 200 and/or the customer. In the exemplary embodiment, the query data may include a text query, “What are the directions to the hotel?”. The modified query data resulting from processing the query data may include, for example, “directions” and “directions+hotel.”

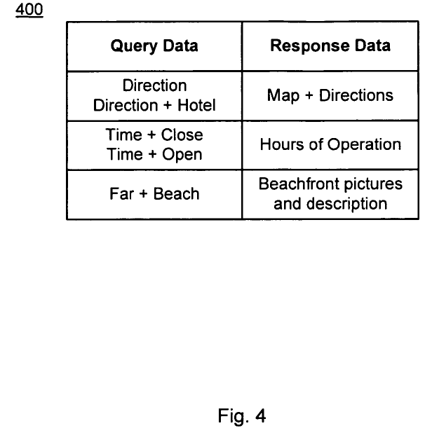

In step 308, it is determined whether the response data corresponding to the query data is available. As shown in FIG. 4, the query data and the response data may be contained in a look-up table 400 (or other data structure). Thus, in the above example, the query data “directions” and “directions+hotel” point to a same response data, “map+directions.” Additionally or alternatively, the response data may include a response query to discern a meaning/intent of the query data and/or to provide more detailed information about the response data. For example, the response query may include a question, “What is your departure address?”. Customer response data entered in response to the response query may be processed in a similar manner as described above to identify detailed/customized response data.

In step 310, the query data does not correspond to any of the response data and an error message may be output via the ACSR 214. The error message may, for example, ask the customer to rephrase the query data or contact a live customer service representative. Alternatively, the error message may establish a chat session and/or phone call with a live customer service representative. When the chat session begins, the ACSR 214 may be minimized to prevent confusing the customer.

In step 312, the response data identified using the query data is output via the ACSR 214. The response data may include any one or combination of a text response, an image response, a video response and an audible response. In one embodiment, the text response may be converted into a corresponding audible response by a text-to-speech conversion arrangement. The corresponding audible response may be stored at the search server 104 and/or output via the ACSR 214.

In the above example, the response data includes a map image, a text description of directions to the hotel and an audio description of the directions. The response data is downloaded to the client device 104 and the map image is displayed in the web browser. The text description and the audible description may be output substantially simultaneously, and the ACSR 214 may be animated in conjunction with playback of the audio description (e.g., to simulate that the ACSR 214 is speaking to the customer). In other embodiments, the text description may be output in a following manner to the audible description, allowing the customer to read the text description while hearing the audible description. In a further embodiment, a portion(s) of the map image may be selectively highlighted in conjunction with the output of the text and/or audible description.

The query data and the response data identified during a communication session (e.g., while the customer visits the website) may be stored in a log maintained at the server 102. The log may be analyzed manually or by, for example, a learning algorithm to evaluate accuracy of the response data. For example, the log may record a customer identification which, when reviewing previous transactions, indicated that the customer made several calls to the live customer service representative and did not complete the transactions on the website. However, when accompanied by the ACSR 214, the customer may have completed the transaction on the website. Thus, post-session analysis may be useful to refine and/or generate new response data and/or updating the look-up table 400. The log may also be downloaded to the client device 104 upon receipt of a customer request or automatically when the session terminates.

In the exemplary embodiment in which the ACSR 214 is user-specific and used across multiple websites, applications, etc., the lookup table 400 may be updated at a predetermined interval. For example, when the client device 104 is connected to the network 106 (or through use of a data storage medium), the query and/or response data in the lookup table 400 may be added to, removed from or otherwise modified.

As stated above, the ACSR 214 may also be used to respond to machine events and/or perform error checking. For example, the customer may be entering the purchase data into the purchase form on the webpage 200. The customer may enter data in each of the fields, but forget to enter data in the credit card expiration date field 212. If the customer clicks a Submit button or scrolls past the field 212 (e.g., so that it is no longer viewable on a display screen), the ACSR 214 may output an alert, “You forgot to fill out the credit card expiration date!”. In another instance, the ACSR 214 may respond to a predetermined sequence of machine events. For example, if the customer double-clicks in a field (e.g., the name field 206), the ACSR 214 may interpret the predetermined sequence as query data and output the response data, “Enter the name as it appears on the credit card that you are paying with.”.

FIGS. 1 through 4 are conceptual illustrations allowing for an explanation of the present invention. It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer program medium” and “computer usable medium” are used to generally refer to media such as a random access memory (RAM); a read only memory (ROM); a removable storage unit (e.g., a magnetic or optical disc, flash memory device, or the like); a hard disk; electronic, electromagnetic, optical, acoustical, or other form of propagated signals (e.g., carrier waves, infrared signals, digital signals, etc.); or the like.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments will so fully reveal the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

What is claimed is:

1. A method, comprising:
receiving query data via a website;
identifying response data based on the query data, the response data including audible response data and visual response data;
outputting the audible response data via an audible output device; and
outputting the visual response data on a display.

2. The method according to claim 1, wherein the audible response data and the visual response data are output substantially simultaneously.

3. The method according to claim 1, wherein the query data includes at least one of text query data, audible query data and a machine event.

4. The method according to claim 1, wherein the identifying includes:
identifying at least one predetermined term in the query data;
generating modified query data using the at least one predetermined term; and
selecting the response data from a response database based on the modified query data.

5. The method according to claim 1, wherein audible response data is one of an audio file and an address of the audio file.

6. The method according to claim 5, wherein the address is a Uniform Resource Locator.

7. The method according to claim 1, wherein the visual response data includes at least one of text response data, video response data and animation response data.

8. The method according to claim 6, wherein the animation response data is an animated graphic.

9. The method according to claim 1, further comprising:
storing the query data and query session data.

10. The method according to claim 9, wherein the query session data includes at least one of a user identifier and a timestamp.

11. A system, comprising:
a database storing a plurality of response data files, the response data files including audible response files and visual response files, each of the audible response files associated with a corresponding one of the visual response files; and
a host device receiving query data, the host device selecting one of the response data files based on the query data.

12. The system according to claim 11, wherein the host device outputs the selected response data file to a source of the query data.

13. The system according to claim 11, wherein each of the response data files is associated with one or more predetermined terms.

14. The system according to claim 13, wherein the host device identifies the one or more predetermined terms in the query data and selects the response data file based on the identified one or more predetermined terms.

15. The system according to claim 11, wherein the database stores the query data.

16. The system according to claim 11, wherein the database associates the query data with the selected response data file.

17. The system according to claim 11, wherein the query data includes at least one of text query data, audible query data.

18. A computer-readable storage medium storing a set of instructions, the set of instructions capable of being executed by a processor, the set of instructions performing the steps of:
receiving query data;
identifying response data based on the query data, the response data including audible response data and visual response data; and
outputting substantially simultaneously the audible response data and the visual response data.

19. The storage medium according to claim 18, wherein the set of instructions further performs the steps of:
identifying at least one predetermined term in the query data;
generating modified query data using the at least one predetermined term; and
selecting the response data from a response database based on the modified query data.

20. The storage medium according to claim 18, wherein the set of instructions further performs the steps of:
storing the query data.
